(19) United States
(12) Patent Application Publication
(10) Pub. No.: US 2007/0294699 A1
(43) Pub. Date: Dec. 20, 2007

(54) CONDITIONALLY RESERVING RESOURCES IN AN OPERATING SYSTEM

(75) Inventors: Pradeep Bahl, Redmond, WA (US); Narasimha Rao S. S. Nagampalli, Kirkland, WA (US); Ramesh Chinta, Sammamish, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/424,681

(22) Filed: Jun. 16, 2006

(51) Int. Cl. G06F 9/46

(52) U.S. Cl. 718/104

(57) ABSTRACT

A facility is provided for conditionally reserving resources in an operating system. In various embodiments, the facility receives an indication of a conditional reservation declarator that identifies at least a resource, an action, a condition, and a principal. The conditional reservation declarator can specify a directive that corresponds to the identified resource, action, condition, and principal. The facility configures itself to apply the specified directive in relation to the identified action and resource when the principal attempts to perform the identified action in relation to the identified resource and the condition is met. The facility can apply the specified directive when it determines that the principal is attempting to perform the identified action on the identified resource when the condition is met.

### BACKGROUND

Malicious software (“malware”) is a type of software that is generally harmful to computer systems or operating systems. Malware includes computer worms, viruses, Trojan horses, spyware, and so forth. Some malware behave nefariously, such as by illicitly collecting and transmitting personal information. Some malware can hijack resources needed by operating system components or use these resources to subvert the security of the operating system. For example, such malware can cause an unprotected network resource to open a TCP/IP port that allows a third party to access the operating system's resources.

Many techniques have been used to help detect the presence of such malware. Unfortunately, detection of some malware has proved to be difficult. One technique attempts to identify the presence of malware by the presence of an open port. Malware may install a backdoor so that the computer system can be accessed at a later time. The backdoor opens a port through which another computer system can gain access to the infected computer system. The technique can initiate a port scan from another computer system to detect the presence of an open port. Another technique may compare the files of the infected operating system with files of a non-infected or “clean” operating system. In particular, the technique may generated hash codes for the files of the infected operating system and compare them to hash codes of the clean operating system. However, since the malware may have total control over the computer system, it can provide the clean version, rather than the infected version, of a file to a program that is calculating the hash codes.

Some techniques for detecting and disabling malware include installing anti-malware software and hardware products, such as antivirus and antispyware software, firewalls, and so forth. Unfortunately, anti-malware products have not been entirely successful because software developers who create malware have adapted to these anti-malware products. Malware can attach to dynamically created or used resources and can block creation or use of resources. As an example, malware can wait for a particular network port to open and can begin using that port maliciously. Alternatively, malware can prevent the port from opening and thereby prevent other applications or services from functioning as designed. Preventing such activities of malware is conventionally difficult.

### SUMMARY

A facility is described for reserving resources associated with an operating system for identified principals, whether or not such resources and principals have already been created. By reserving operating system resources, the facility prevents subversion or hijacking of the resources. The facility can receive conditional reservation declarators to reserve resources when specified conditions are met. An administrator of the operating system or a software component can specify the conditions. The facility is extensible in that plug-ins provided to the facility can assist the facility in reserving or otherwise controlling access to resources even when the facility was not originally configured for reserving such resources.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIGS. 1A-1B are block diagram illustrating examples of suitable computing environments in which the facility may operate in various embodiments.

FIGS. 2-3 are block diagrams illustrating configurations of the facility in various embodiments.

FIG. 4 is a flow diagram illustrating a configure routine invoked by the facility in some embodiments.

FIG. 5 is a flow diagram illustrating a user mode load_configuration_settings routine invoked by the facility in some embodiments.

FIG. 6 is a flow diagram illustrating a kernel mode load_configuration_settings routine invoked by the facility in some embodiments.

FIG. 7 is a flow diagram illustrating an enforce routine invoked by the facility in some embodiments.

FIG. 8 is a block diagram illustrating components associated with the facility in various embodiments.

### DETAILED DESCRIPTION

A facility is described for reserving resources associated with an operating system for identified principals, whether or not such resources and principals have already been created (“the facility”). By reserving operating system resources, the facility prevents subversion or hijacking of the resources. Principals of an operating system include, but are not limited to, the operating system's users, applications, services, and virtual machines. Principals can be identified by globally unique identifiers, names, paths, and so forth. As an example, an application can employ the facility to reserve a registry hive and a set of TCP/IP ports. A registry hive is a collection of registry keys. When the facility reserves a resource for a principal, the facility authorizes the principal to take various actions on the reserved resource and may prevent other principals (including malware) from creating, accessing, or using the resource. As an example, when the facility reserves a file for an identified principal, the facility authorizes that principal to create the file if the file does not yet exist. As another example, if the facility reserves a registry hive for a service, the facility authorizes the service to add registry keys to the registry hive but prevents other services and applications from doing so. By enabling reservation of resources for principals, the facility is able to prevent hijacks or other malicious use of reserved resources by malware. In various embodiments, a principal can reserve a resource for itself or another principal. As an example, an application can, during its installation, reserve a network port for its sole use. As another example, the operating system or some other principal can reserve a filename or file folder for use by a principal (e.g., an application or service) that has not yet been installed. As another example, when the facility reserves a resource that does not yet exist for a principal, whether or not that principal already exists, only that identified principal may be able to create the specified resource. Thus, principals can reserve resources or benefit from the reservation of resources whether or not the resources or principals already exist when the reservation is made.

The facility can receive authorization settings that provide an indication of resources that are to be reserved for indicated principals, such as when a principal is installed. The authorization settings also indicate what actions principals can or cannot take in relation to an indicated resource. When the facility receives these reservations, it provides the authorization settings to appropriate kernel mode and user mode operating system components that can reserve the resources. When a principal attempts to perform an action in relation to a resource, a kernel mode component or a user mode component determines whether the principal is authorized to perform the requested action. If the principal is not so authorized, the kernel mode component or the user mode component prevents the action from occurring.

Neither the resource nor the principal needs to exist when the facility reserves the resource for the principal. As an example, the facility enables a principal to reserve a TCP/IP port even though that port does not exist until the principal creates it. As another example, the facility may reserve a particular TCP/IP port for an application even though that application has not been installed on the operating system. In some embodiments, the facility can reserve any resource that is identifiable. As an example, the facility can reserve a non-existent resource that has a name or identifier (e.g., a filename).

The reservations can employ conditional authorization settings. As an example, a media player application may be able to download media only during specified times. Conditions can include start time, end time, geographic or network location, a state or other attribute of the operating system or the computer system, occurrence of various events, reputation rating, risk profile, duration of an activity or action, rate of use, existence of a resource, and so forth, and may be combined with logical operators to form complex conditions. These conditions can relate to principals, resources, users, or other aspects of the operating system or facility. As an example, a principal having a poor reputation rating may be unable to open a network port that does not exist. As another example, a user having a high risk profile may be unable to download an ACTIVEX control from a web site that is not indicated to be trusted or whose trust level is unknown. The conditions can be specified explicitly or implicitly. As an example, a reservation or other authorization setting can explicitly specify a condition such as start and end times for ensuring that an identified resource (e.g., a game application) is available or unavailable during the specified period of time. As another example, a reservation can reserve a CREATE action on a resource for an identified principal. Such an authorization setting employs an existence condition implicitly because a CREATE action will fail if the resource already exists. Thus, the facility can provide conditional reservations (which can be referred to as “conditional directives”). A directive may indicate an action on a resource that is to be authorized or denied.

Examples of uses of conditional authorization settings now follow. When an administrator specifies that only an identified application can create a particular file, the facility prevents other applications from creating such a file. When a reservation associated with an application specifies that only that application is to create an object such as a named synchronization object, mutex, or event, the facility prevents other applications from creating such an object. When an administrator of a portable computer specifies that file and print sharing is to be disabled when the portable computer operates on a public network, the facility disables network ports associated with file and print sharing when the portable computer is connected to a public network. When an administrator specifies that a particular user can only access a resource five times in a twenty-four hour period, the facility prevents the user from accessing the resource a sixth time prior to the expiry of that twenty-four hour period. The facility enables these and other conditional reservations of resources.

The facility can reserve various resources of the operating system including, e.g., files, folders, registry keys, registry hives, physical and virtual network interfaces, virtual local area networks, IP addresses or ranges, IP subnets, TCP ports, UDP ports, applications, services, mutexes, semaphores, processor time, network bandwidth, storage space, or any other identifiable resource. The resources may be identified in a type-specific way. As an example, a file or folder can be identified by a path whereas an IP address or IP subnet can be identified by an IP number.

In some embodiments, the facility employs an access control mechanism to make reservations. As an example, the facility employs a system protection service (“SPS”) of the MICROSOFT WINDOWS operating system. The SPS can determine whether access control permissions on a resource indicate whether a requested operation should be authorized or denied. In some embodiments, the SPS intervenes when an operating system component makes a reservation relating to a nonexistent resource. The facility receives indications of access control and directs the SPS to enforce access control permissions accordingly. The facility may receive the indications of access control from principals, a user, a configuration file, and so forth. The indications of access control are sometimes referred to as access control rules, access control constructs, access control settings, authorization settings, and so forth.

In various embodiments, the facility employs lists of authorizations as authorization settings. An allowed-list authorization specifies allowable actions. A prohibited-list authorization specifies prohibited actions. When the facility employs allowed-list authorization, the facility can allow authorized principals to take various actions. As an example, the facility can allow a principal to “listen” for connections on a specified TCP port. The facility may receive this allowed-list authorization setting from a principal as follows:
T(P1-WC-TCP) {ALLOW OPEN <sid1>}

In this authorization setting, the “T” before the first parenthesis indicates that the authorization applies to a transport-layer resource. The “P1” after the first parenthesis indicates that the resource is source port number P1. The “WC” indicates that the port P1 can be open on any source IP address. “WC” is an acronym for “wildcard.” “TCP” is the transport-layer protocol. The “ALLOW OPEN <sid1>” in the braces indicates that the authorization is to allow the principal identified by <sid1> to open the port. A “sid” is an identifier, such as a globally unique identifier, for a principal. The “<sid1>” is an identifier for a principal. According to this authorization setting, any other principal (e.g., a principal that is not identified by <sid1>) should not be able to open the port.

When the facility employs prohibited-list authorization, the facility can deny specified unauthorized principals from taking various actions. As an example, the facility can deny a principal identified as <sid2> from opening a port P1 on a network address A1 using the following authorization setting:
T(P1-A1) {DENY OPEN <sid2>}

Thus, the facility employs authorization settings to indicate a directive in relation to actions a principal attempts to take on a resource, even when the resource does not yet exist in the operating system.

In some embodiments, when an allowed-list authorization is defined, the facility may automatically deny principals who are not indicated as authorized in the allowed-list. Likewise, when a prohibited-list authorization is defined, the facility may automatically allow principals who are not indicated as prohibited in that list. In various embodiments, when no authorization is defined (e.g., prohibited-list or allowed-list), all principals are either provided authorization or denied authorization depending on a default setting indicated to the facility.

In general, the facility accepts authorization settings that are indicated as resources followed by authorizations. An example of a resource is a network object, such as a TCP/IP port. Network objects can be indicated using one or more values, which may be referred to as a “1-tuple,” “2-tuple,” “3-tuple,” “4-tuple,” “5-tuple,” and so forth. These values appear as a tuple in parentheses near an indication of the network object type to which the tuple relates. Network objects generally relate to various network layers. In various embodiments, there can be a one-to-one relationship between a “network layer” as defined in the Open Systems Interconnect (“OSI”) network communications model and a “network object” type. One or more authorizations specified within braces can follow an indicated network object type. Authorizations are generally specified as ALLOW or DENY followed by an action that the facility is to allow or deny and then an indication of a set of principals. Table 1 provides additional examples of authorization settings.

TABLE 1
Examples of Authorization settings

| Authorization setting | Meaning |
|---|---|
| T(1024–65535) {ALLOW OPEN | Transport-layer ports in the range 1024 to 65535 are |
| CertAppGrpSid} | reserved for principals in the CertAppGrpSid group, any |
| | of which is allowed to open a port in the indicated |
| | range. No principal that is not in the CertAppGrpSid |
| | group can use any port in this range. |
| (HKLM\System\CCS\Services\WINS) | Only the principal identified by WINSSid can create |
| {ALLOW CREATE WINSSid} | registry keys in the |
| | HKeyLocalMachine\System\CCS\Services\WINS |
| | registry hive. |
| (<URL>) {DENY GET childsid} | The principal identified by childsid cannot access the |
| {ALLOW GET adultsid} | URL indicated by <URL>, but the principal identified by |
| | adultsid can. |
| T(WC, 123.45.6.7) {ALLOW OPEN | No principal other than the one identified by |
| DHCPServerSid) | DHCPServerSid can use the IP address 123.45.6.7, no |
| | matter which source port (e.g., identified by the wildcard |
| | WC) this principal uses. |
| T(WC, 123.45.*.*) {DENY OPEN | Allow any principal to use the IP subnet identified by |
| AppGrpSid} {ALLOW OPEN | 123.45.*.* except principals identified by the group |
| EVERYONE} | AppGrpSid. |
| D(VLANWorkGroupAId) {ALLOW OPEN | Any principal identified by the WorkGroupAppGrpSid |
| WorkGroupAppGrpSid} | group can open the data link layer object identified by |
| | VLANWorkGroupAId, which identifies a virtual local |
| | area network. |
| (% SystemRoot %\DHCP\dhcp.log | Only the principal identified by DHCPClientSid can |
| {ALLOW CREATE DHCPClientSid} | create a file named “dhcp.log” in the |
| | % SystemRoot % \DHCP\folder. |

The facility receives these authorization settings and provides them to various drivers and other components that enforce the authorizations indicated by the authorization settings. In various embodiments, the facility provides a filtering platform that receives plug-ins associated with various resource types. When a principal accesses a resource for which the facility has an associated plug-in, the facility requests the plug-in to determine whether an action requested by the principal should be allowed or denied. As an example, when an authorization setting reserves a particular transport-layer port for use only by principals identified by a group's “sid,” a transport layer plug-in of the facility that enforces the authorization setting can deny other principals that attempt to access that port. Thus, by reserving resources for principals, the facility is able to prevent some types of malware from operating successfully on an operating system configured to employ the facility.

In various embodiments, the authorization settings can be provided as a part of a conditional reservation declarator. Conditional reservation declarators have metadata fields, resource fields, and condition fields. The metadata fields identify attributes relating to the conditional reservation. These are the name, description, version number, change number, and history fields. The name, description, and version fields are specified by an administrator (e.g., as strings or numerical values) to uniquely identify and describe the conditional reservation. The facility increments the change number field every time the conditional reservation is modified, such as by an administrator. The facility tracks changes to conditional reservation declarators in their respective history fields. The conditional reservation declarator may also have additional metadata fields.

In various embodiments, the resource fields identify the resources to which the corresponding conditional reservation declarator applies. In general, an administrator specifies the resource fields. The resource fields include a name, type, static, visibility and reputation. The name field identifies a resource by name. In various embodiments, the resource fields can include an alternate identification of the resource, such as a globally unique identifier. The type field identifies the type of resource, such as events, semaphores, files, registry, process, and so forth. The static field identifies whether the resource is static or dynamic. Whether a resource is static or dynamic depends on whether the resource persists beyond the life of its creator. The visibility field specifies the visibility of the resource to principals. As an example, the resource can be visible only to locally operating principals, remotely operating principals, or both. The reputation field specifies the reputation of the resource. As examples, an administrator can specify a level of trust to be associated with the resource, such as by using a numerical value. The conditional reservation declarator may also have additional resource fields.

In various embodiments, the condition fields specify conditions under which the corresponding conditional reservation declarator applies. In general, an administrator specifies the condition fields. Examples of condition fields include start time, end time, rate limits, duration, location, and risk level. The start and end times fields specify the times after and before which the conditional reservation declarator applies, respectively. The rate limits field specifies limits on the frequency or count of actions taken on resources by principals. As examples, the facility can use this field to restrict the number of times a resource can be accessed per second, the number of inbound or outbound TCP/IP connections per second, number of times a user can attempt to log into an account before the account is disabled, and so forth. The duration field the number of times or time span during which the facility should enforce the authorization setting specified by the corresponding conditional reservation declarator before disabling that declarator. The location field specifies the network location for the associated computing device on which the facility is to enforce the conditional reservation declarator. As examples, the facility may enforce the authorization setting specified by the corresponding conditional reservation declarator when the associated computing device is on a home network but not on an office network. The risk level field specifies the risk level above which the facility is to enforce the conditional reservation declarator. As an example, the facility can enforce the authorization setting specified by the corresponding conditional reservation declarator when the associated computing device is at higher risk, such as when it is connected to an open network that does not have a firewall. The conditional reservation declarator may also have additional resource fields.

In various embodiments, the fields associated with a conditional reservation declarator can be applied together in a group. As an example, an administrator can apply start and end times together as a group.

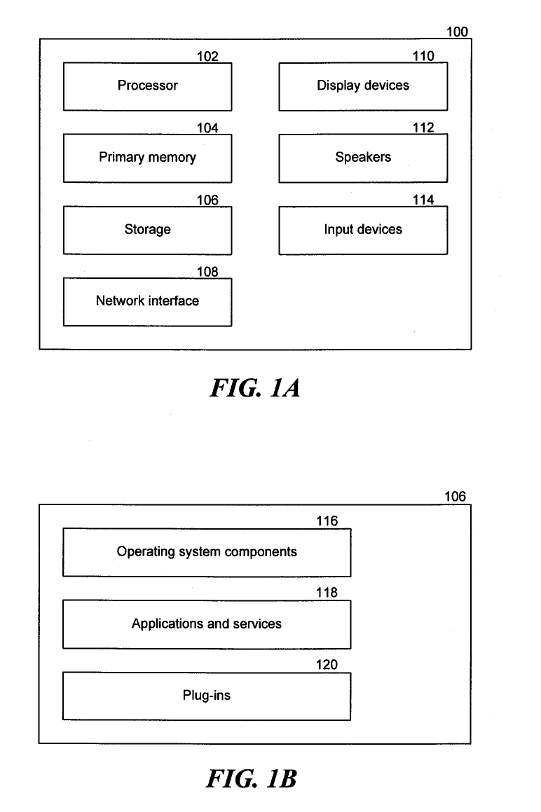

Turning now to the figures, FIGS. 1A-1B are block diagram illustrating examples of suitable computing environments in which the facility may operate in various embodiments. FIG. 1A is a block diagram illustrating an example of a suitable computing environment 100 in which the facility may be implemented. A system for implementing the facility includes a general purpose computing device in the form of the computing system 100 (“computer”). Components of the computer may include, but are not limited to, a processing unit 102, a system primary memory 104, a storage device 106, a network adapter or interface 108, one or more display devices 110, one or more speakers 112, and one or more input devices 114.

The computer 100 typically includes a variety of computer-readable media that are operable with the storage device 106. Computer-readable media can be any available media that can be accessed by the computer 100 and include both volatile and nonvolatile media and removable and nonremovable media.

The computer 100 may operate in a networked environment using logical connections to one or more remote computers. A remote computer may be a personal computer, a server, a router, a network PC, a peer device, or other common network node, and typically includes many or all of the elements described above in relation to the computer 100. A logical connection can be made via a local area network (LAN) or a wide area network (WAN), but may also include other networks. Such networking environments are commonplace in homes, offices, enterprisewide computer networks, intranets, and the Internet. The computer 100 can be connected to a network through a network interface or adapter 108, such as to a wired or wireless network.

The computer 100 is only one example of a suitable computing environment and is not intended to suggest any limitation as to the scope of use or functionality of the facility. Neither should the computing system be interpreted as having any dependency or requirement relating to any one or a combination of the illustrated components.

The facility is operational with numerous other general purpose or special purpose computing systems or configurations. Examples of well-known computing systems, environments, and/or configurations that may be suitable for use with the facility include, but are not limited to, personal computers, server computers, handheld or laptop devices, cellular telephones, tablet devices, multiprocessor systems, microprocessor-based systems, set-top boxes, programmable consumer electronics, network PCs, minicomputers, mainframe computers, distributed computing environments that include any of the above systems or devices, and the like.

The facility may be described in the general context of computer-executable instructions, such as program modules, that are executed by a computer. Generally, program modules include routines, programs, objects, components, data structures, and so forth that perform particular tasks or implement particular abstract data types. The facility may also be employed in distributed computing environments where tasks are performed by remote processing devices that are linked through a communications network. In a distributed computing environment, program modules may be located in local and/or remote computer storage media, including memory storage devices.

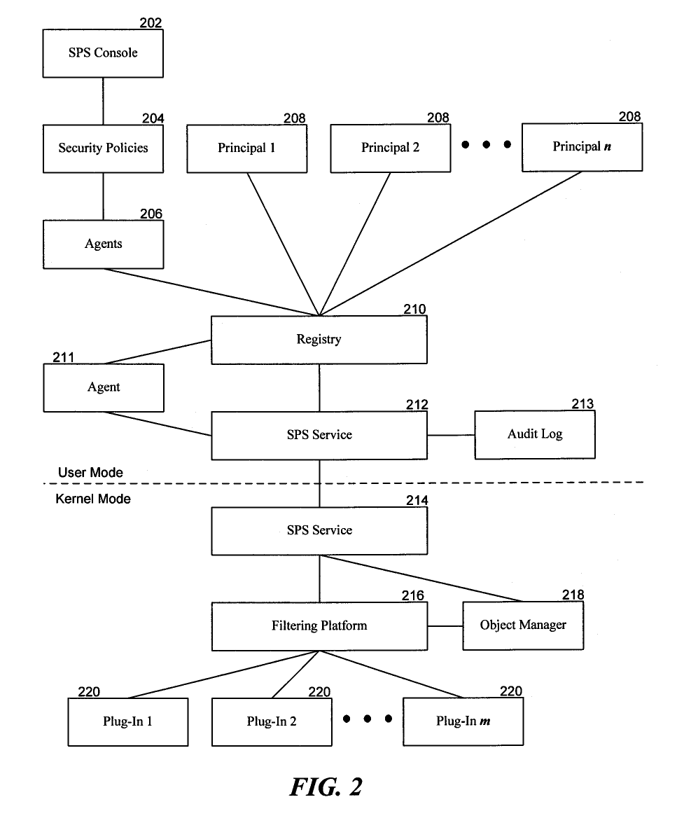

FIG. 1B is a block diagram illustrating a storage device of FIG. 1A in further detail. According to the illustrated embodiment, the storage device 106 stores an operating system and its components 116, applications and services 118, and plug-ins 120. The operating system can be MICROSOFT WINDOWS, APPLE MACINTOSH, LINUX, UNIX, or other operating systems. The operating system has a user mode and a kernel mode. The applications and services generally operate in user mode, but some can operate in kernel mode. In kernel mode, the operating system generally functions with input and output devices, and performs other fundamental or core functions associated with the operating system. The plug-ins are components that extend the facility. The plug-ins provide an ability for the facility to be extended, such as to reserve resources that the facility was not originally configured to reserve. As an example, an administrator can add plug-ins that the facility employs to reserve resources that the facility was not previously configured to reserve. Examples of plus-ins are described in further detail below, such as in relation to FIG. 2.

An operating system performs various tasks relating to a computer system, such as managing hardware, software, operating, and network resources. Hardware resources include processors, primary storage (e.g., memory), secondary storage (e.g., hard disk or optical disk), printers, display adapters, network interface cards, input/output ports, etc. Software resources include application programs, user interfaces, device drivers, etc. Operating resources include files, registry keys, named pipes, etc. Network resources include network ports (e.g., relating to a transport control protocol (“TCP”), internet protocol (“IP”), user datagram protocol (“UDP”)), subnets, addresses, interface cards, network protocol stacks, etc. The operating system manages and coordinates these resources to complete various tasks, such as under the direction of an application program, service, or other software (referred to herein as an operating system component). Resources are sometimes referred to as “objects” in the art.

While various functionalities and data are shown in FIGS. 1A and 1B as residing on particular computer systems that are arranged in a particular way, those skilled in the art will appreciate that such functionalities and data may be distributed in various other ways across computer systems in different arrangements. While computer systems configured as described above are typically used to support the operation of the facility, one of ordinary skill in the art will appreciate that the facility may be implemented using devices of various types and configurations, and having various components.

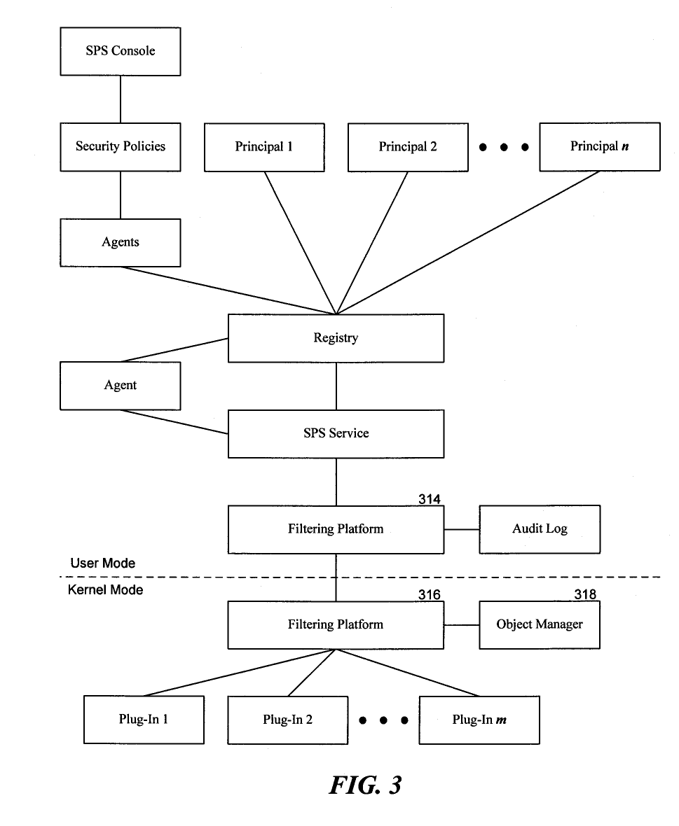

FIGS. 2-3 are block diagrams illustrating configurations of the facility in various embodiments. The configuration of the embodiment illustrated in FIG. 2 will be described first. Various components operate in user mode or kernel mode of the underlying operating system. The components that operate in user mode are illustrated above the dashed horizontal line. The components that operate in kernel mode are illustrated below this dashed horizontal line.

In the illustrated embodiment, the facility has a system protection service (“SPS”) console 202. The SPS console is a tool that an administrator can use to indicate security policies. The administrator can also use the SPS console to provide authorization settings for the facility. The SPS console registers security policies in a security policies component 204. As an example, the SPS console collects input from an administrator to define and store security policies in the security policies component. The SPS console can also register settings in an external repository, such as in MICROSOFT ACTIVE DIRECTORY or MICROSOFT SQL SERVER.

One or more agents 206 may process the security policies that are stored in the security policies component or an external repository to create registry entries that the facility uses to reserve resources. These agents may transform the security policies into authorization settings and store these authorization settings in the registry 210.

Various principals 208 may also register security policies in the security component or store authorization settings in the registry, such as by employing an application program interface (“API”) provided by the facility. Examples of such principals include application installers, parental control applications, services (e.g., daemons), applications, and so forth.

In the illustrated embodiment, a user mode component of the SPS service component 212 communicates authorization settings from user mode to kernel mode in addition to performing other activities. An agent 211 may provide authorization settings stored in the registry to the SPS service user mode component. As an example, the agent may invoke an API provided by the SPS service user mode component to translate the authorization settings stored in the registry for use by the SPS service. The SPS service user mode component may store information relating to its activities in an audit log 213. As an example, the SPS service may employ the audit log to store changes to authorization settings, successful or failed attempts to reserve resources, and so forth.

The SPS service also has a kernel mode component 214, such as a kernel mode driver. The SPS service employs the kernel mode component to provide authorization settings to other kernel mode components. As an example, the SPS service kernel mode component may provide authorization settings to a filtering platform 216, such as WINDOWS FILTERING PLATFORM. The filtering platform provides an API that principals or other operating system components can use to examine, send, remove, or modify TCP/IP packets.

The filtering platform may additionally have one or more plug-ins 220 that enable the filtering platform to provide similar services for other resources, such as for hypertext transfer protocol, remote procedure calls, and so forth. When the operating system evaluates permissions for resources (e.g., files, registry keys, etc.), the operating system may employ an object manager 218 to provide various information, such as information pertaining to permissions. The object manager may in turn request the SPS service kernel mode component to provide this information to it, e.g., by communicating with the SPS service user mode component.

The embodiment illustrated in FIG. 3 is similar to the embodiment illustrated in FIG. 2 except that whereas components of the SPS service enable communication of information between user and kernel modes in the embodiment illustrated in FIG. 2, components of the filtering platform perform this work in the embodiment illustrated in FIG. 3. The filtering platform has a user mode component 314 and a kernel mode component 316. The embodiment illustrated in FIG. 3 does not have a kernel mode SPS service component. The object manager 318 provides information to the operating system via the filtering platform kernel mode component.

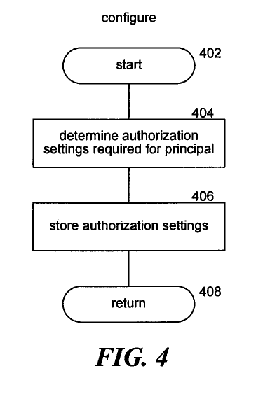

FIG. 4 is a flow diagram illustrating a configure routine invoked by the facility in some embodiments. A principal or an appropriately privileged program may invoke the configure routine to reserve resources that the principal uses. As an example, the principal may invoke the configure routine when the application is installed. The principal could also invoke the configure routine after or before application installation. The routine begins at block 402.

At block 404, the routine determines authorization settings that the invoker of the routine requires. The routine may make that determination by checking a manifest provided by the principal that invoked the routine. As an example, an installation program may provide a manifest file to the facility indicating which files, registry keys, TCP/IP ports, or other resources that an application being installed requires. In some embodiments, the principal may invoke an API provided by the facility to configure the facility. In these embodiments, the principal may provide authorization settings directly, in which case the facility may not perform the logic associated with block 404.

At block 406, the routine stores the determined or received authorization settings. The routine may store these authorization settings in a registry, file, database, or so forth. In some embodiments, the facility may store the authorization settings in a secure portion of the registry. As an example, this portion of the registry may only be modified by a system administrator.

At block 408, the routine returns.

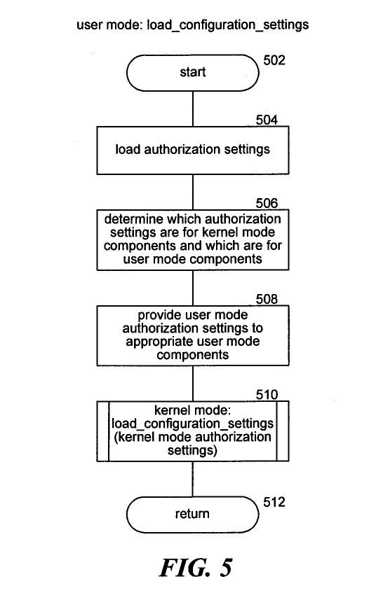

FIG. 5 is a flow diagram illustrating a user mode load_configuration_settings routine invoked by the facility in some embodiments. In various embodiments, a user mode component of the SPS service or filtering platform invokes the load_configuration_settings routine. As examples, the user mode component of the SPS service illustrated in the embodiment of FIG. 2 or the user mode component of the filtering platform illustrated in the embodiment of FIG. 3 may invoke the routine. These components may invoke the routine to provide stored authorization settings to the appropriate components of the facility or operating system. The routine begins at block 502.

At block 504, the routine loads the stored authorization settings. As an example, the routine may load the stored authorization settings from a registry, file, database, or so forth.

At block 506, the routine determines which of the loaded authorization settings are for kernel mode components and which are for user mode components. The routine may make that determination based on which operating system the facility operates in. As an example, the facility may employ a kernel mode component to reserve networking resources but may employ a user mode component to reserve file system resources.

At block 508, the routine provides user mode authorization settings to user mode components to which the authorization settings relate. As an example, the routine may provide authorization settings for reserving files to a user mode operating system component.

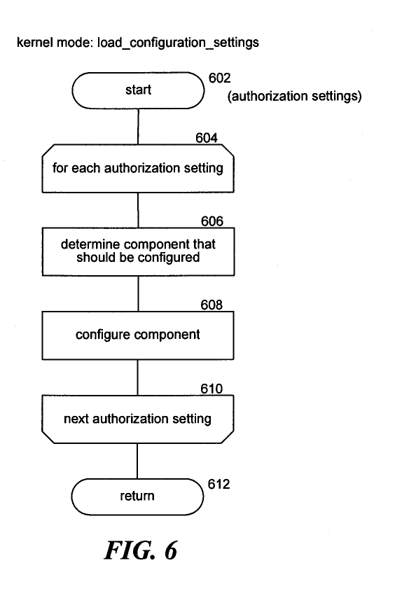

At block 510, the routine invokes a load_configuration_settings subroutine performed by a kernel mode component to provide the kernel mode authorization settings to appropriate kernel mode components. As an example, the routine may invoke a kernel mode SPS service component or a kernel mode filtering platform component. The routine may provide an indication of the loaded kernel mode authorization settings to the kernel mode load_configuration_settings subroutine. This subroutine is described in further detail below in relation to FIG. 6.

At block 512, the routine returns.

FIG. 6 is a flow diagram illustrating a kernel mode load_configuration_settings routine invoked by the facility in some embodiments. The routine begins at block 602 where it receives indications of authorization settings as one or more parameters. The routine may be invoked to provide the authorization settings to kernel mode components that the facility employs to reserve various resources.

Between the loop of blocks 604 to 610, the routine determines which kernel mode components should be configured based on the received authorization settings and configures these components. At block 604, the routine selects an authorization setting.

At block 606, the routine determines which kernel mode component corresponds to the selected authorization setting. As an example, the routine may determine that a networking plug-in of the filtering platform corresponds to an authorization setting indicating that a TCP/IP port is to be reserved for a principal.

At block 608, the routine configures the kernel mode component that the routine identified at block 606. As an example, the routine may provide the selected authorization settings to the identified component. In some embodiments, the routine may configure the identified component by varying properties associated with the component.

At block 610, the routine selects another authorization setting. When all received authorization settings have been processed, the routine continues at block 612, where it returns. Otherwise, the routine continues at block 606.

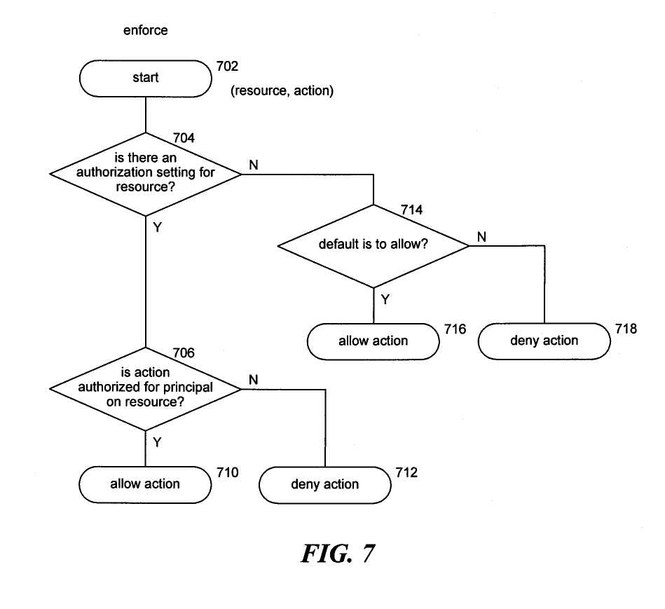

FIG. 7 is a flow diagram illustrating an enforce routine invoked by the facility in some embodiments. Various components of the facility may invoke the enforce routine when a principal attempts to take an action on a resource. As an example, a filtering platform plug-in corresponding to TCP/IP traffic handled by a computing device associated with the facility may invoke the enforce routine when an application attempts to open a TCP/IP port. The routine begins at block 702 where it receives indications of a resource and an action as parameters. In some embodiments, the routine additionally receives an indication of a principal attempting to take the action on the resource.

At block 704, the routine determines whether there is an authorization setting associated with the indicated resource. If there is an indicated authorization setting associated with the resource, the routine continues at block 706. Otherwise, the routine continues at block 714.

At block 706, the routine determines whether the principal is authorized to take the indicated action on the indicated resource. If the principal is so authorized, the routine continues at block 710 where it allows the action to proceed and returns. Otherwise, the routine continues at block 712 where it denies the action and returns.

At block 714, the routine determines whether a default authorization to allow the action is indicated. If the facility is configured to allow actions by default when no authorization setting exists for a resource on which a principal attempts to take an action, the routine continues at block 716 where it allows the action and returns. Otherwise, the routine continues at block 718 wherein it denies the action and returns.

Those skilled in the art will appreciate that the blocks illustrated in FIGS. 4-7 and described above may be altered in a variety of ways. For example, the order of the blocks and their associated logic may be rearranged, additional logic may be performed in parallel, shown blocks may be omitted, or other blocks and associated logic may be included, and so forth.

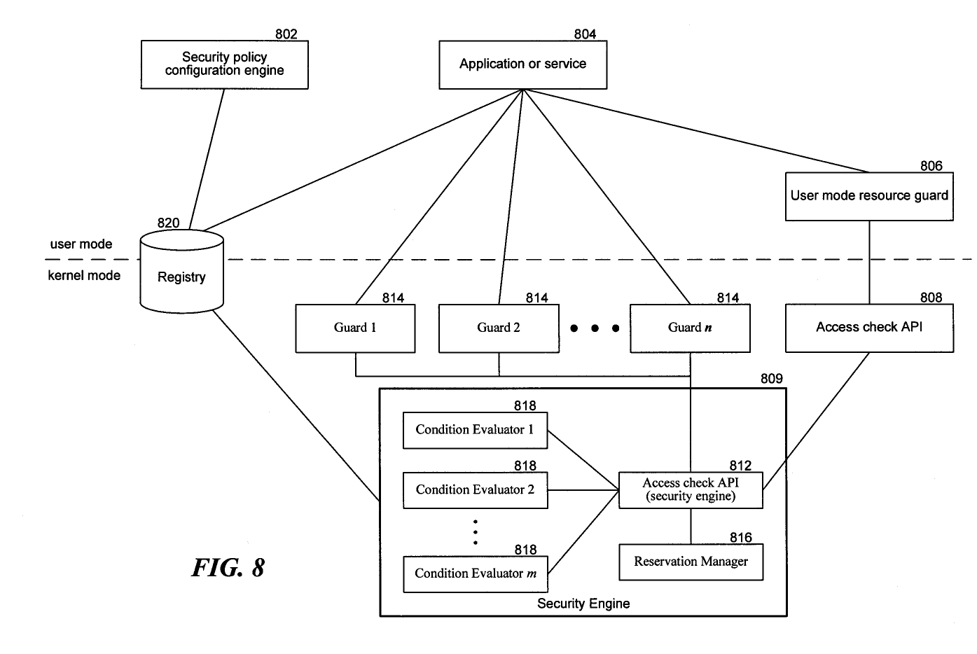

FIG. 8 is a block diagram illustrating components associated with the facility in various embodiments. A security policy configuration engine 802 receives a security policy and configures the facility accordingly. As an example, the security policy configuration engine may create one or more conditional reservation declarators based on the received security policy. The facility can configure the facility by storing information in a registry 820, such as by storing the created conditional reservation declarators. The registry can be stored in any storage, such as disk or random access memory.

Later, when an application or service 804 (or other principal) requests the operating system to perform an action, various “guards” can intercept the action and, in conjunction with the facility, can authorize or deny the action. As an example, a user mode resource guard 806 can intercept various user mode actions requested by the application or service and request, via an access check API 808, the facility to authorize or deny the requested action. The access check API requests an access check API component 812 associated with a security engine 809 to authorize or deny the requested action. In some embodiments, the security engine can be an extensible version of the SPS or an extensible component of the SPS.

Other guards 814 also request the security engine's access check API to authorize or deny various actions that principals (e.g., applications or services) request. Examples of other guards are those that intercept actions relating to files, registries, networks, uniform resource locators, and so forth. Thus, for example, when a principal retrieves or stores a file, a file guard can intercept the action. The guards can operate in kernel mode and request the access check API associated with the security engine to authorize or deny the requested action.

The security engine provides the access check API so that other components can request the security engine to interpret security configuration information such as conditional reservation declarators to authorize or deny actions that principals or other components request. When an action is requested, the security engine's access check API component can request a reservation manager 816 to determine whether a resource (e.g., a nonexistent resource) has been reserved. As an example, when a principal attempts to create a file, the reservation manager can inform the security engine that the file has been reserved by another resource. In such a case, the security engine can deny the file creation action. The security engine's access check API component can also request various condition evaluators 818 to evaluate stored conditions relating to the resource, such as conditions relating to stored conditional reservation declarators. The condition evaluators can inform the security engine's access check API whether a specified condition has been met. As an example, when a browser attempts to open a URL that has been specified in a conditional reservation declarator to be unauthorized between 9:00 a.m. and 5:00 p.m., a condition evaluator can inform the security engine whether or not the stated time and duration conditions are met. The security engine's access check API can then authorize or deny the action accordingly.

In various embodiments, an administrator or software component can extend the system by adding plug-ins. As examples, the administrator or software component can add condition evaluator plug-ins or guard plug-ins. Thus, the facility is extensible to evaluate arbitrary conditions. Moreover, multiple guards can be added to adapt to varying vulnerabilities in protected and unprotected resources that future malware exploits.

It will be appreciated by those skilled in the art that the above-described facility may be straightforwardly adapted or extended in various ways. For example, the facility can be adapted to reserve processor time, network bandwidth, disk space, and so forth. While the foregoing description makes reference to particular embodiments, the scope of the invention is defined solely by the claims that follow and the elements recited therein.

We claim:

1. A computer-readable medium having computer-executable instructions for performing a method of conditionally reserving resources in an operating system, the method comprising:
receiving an indication of a conditional reservation declarator, the conditional reservation declarator identifying at least an operating system resource, a condition, and an action that a principal can attempt to perform in relation to the operating system resource, the operating system resource not yet created in the operating system, the authorization setting specifying at least a directive that corresponds to the identified operating system resource and action, the directive indicating whether the identified action is to be allowed or denied, the condition specifying a circumstance under which the directive is to be enforced;
selecting from a set of enforcement components corresponding to the operating system an enforcement component that is to enforce the specified directive, the enforcement component operating either in a user mode or a kernel mode of the operating system and configurable to apply the directive on actions the principal attempts to take on the identified operating system resource; and
enforcing the directive when the condition identified by the conditional reservation declarator is met even when the operating system resource has not yet been created in the operating system.

2. The computer-readable medium of claim 1 wherein the receiving includes loading the indicated conditional reservation declarator from a registry.

3. The computer-readable medium of claim 1 wherein the conditional reservation declarator indicates an authorization setting.

4. The computer-readable medium of claim 1 wherein the enforcing includes evaluating, by a condition evaluator, the condition identified by the conditional reservation declarator.

5. A system for conditionally reserving resources in an operating system, comprising:
an operating system having a storage that stores conditional reservation declarators;
an operating system component that has a user mode subcomponent and a kernel mode subcomponent wherein the user mode subcomponent receives indications of authorization settings that are stored in the operating system's storage; and
an enforcement component that configures itself to enforce directives specified in the conditional reservation declarator and enforces the directives when a principal attempts to perform an action in relation to a resource, the action and resource indicated in the authorization setting that the operating system component received, the conditional reservation declarator indicating a condition, the enforcement component operating in kernel mode and evaluating the condition.

6. The system of claim 5 wherein the conditional reservation declarator specifies an authorization setting.

7. The system of claim 5 wherein the condition is a start time and the directive is enforced when the action is requested after the start time.

8. The system of claim 5 wherein the condition is an end time and the directive is enforced when the action is requested before the end time.

9. The system of claim 5 wherein the condition is a rate limit and the directive is enforced when the limit is reached.

10. The system of claim 5 wherein the condition specifies a location and the directive is enforced when the operating system operates at the specified location.

11. The system of claim 5 wherein the directive is to deny the action.

12. The system of claim 11 wherein the action is to open a TCP/IP port.

13. The system of claim 5 further comprising a plug-in that evaluates conditions wherein the plug-in is added to the system.

14. The system of claim 5 wherein the directive is to allow the action.

15. The system of claim 14 wherein the directive is to open a file for writing.

16. A method performed by a computer system for reserving resources in an operating system, comprising:
receiving an indication of a conditional reservation declarator that identifies at least a resource, an action, a condition, and a principal, the conditional reservation declarator specifying a directive that corresponds to the identified resource, action, condition, and principal;
configuring to apply the specified directive in relation to the identified action and resource when the principal attempts to perform the identified action in relation to the identified resource and the condition is met;
determining that the principal is attempting to perform the identified action on the identified resource and whether the condition is met; and
applying the specified directive when the condition is met.

17. The method of claim 16 wherein the receiving includes receiving an indication of an authorization setting specifying that a network interface card is to be reserved for the principal.

18. The method of claim 16 wherein the configuring includes configuring to apply the specified directive even when the identified resource does not exist on the operating system.

19. The method of claim 16 wherein the configuring includes configuring to apply the specified directive even when the identified principal does not exist on the operating system.

20. The method of claim 16 wherein the conditional reservation declarator identifies multiple conditions.
